(19) United States
(12) Patent Application Publication
(10) Pub. No.: US 2020/0219106 A1
(43) Pub. Date: Jul. 9, 2020

(54) BIOMETRIC-ENABLED INTERNET OF THINGS (IOT) DEVICE

(71) Applicant: International Business Machines Corporation, Armonk, NY (US)

(72) Inventor: Sreekanth R. Iyer, Bangalore (IN)

(21) Appl. No.: 16/242,409

(22) Filed: Jan. 8, 2019

(51) Int. Cl. G06Q 20/40; G06Q 20/04

(52) U.S. Cl. CPC G06Q 20/40145; G06Q 20/0453

(57) ABSTRACT

An approach for dynamically authenticating an identity of a user using an Internet of Things (IOT) device and empowering the IOT device to purchase, using an identity-linked financial account, a product or service on behalf of the authenticated user is provided. In an embodiment, a user performs an action on an input component (e.g., presses a button) of an IOT device to initiate a purchase transaction. Using captured biometric data of the user, an identity of the user is authenticated against an identity system, such as the Aadhaar-enabled biometric identification system. An identity-linked financial account is identified for the authenticated user. A payment is then authorized using the financial account to complete the purchase transaction.

### TECHNICAL FIELD

In general, embodiments of the present invention relate to an Internet of Things (IOT) device. Specifically, embodiments of the present invention relate to an approach for dynamically authenticating an identity of a user using an IOT device and empowering the IOT device to purchase, using an identity-linked financial account, a product or service on behalf of the authenticated user.

### BACKGROUND

In today's world, Internet of Things (IoT) devices exist that can be used to send notifications or order products from the Internet by just a push of a button. For example, an Amazon Dash® button is a small electronic device designed to allow a person to order products from an online retailer at the push of a button. (Dash is a registered trademark of Amazon.com, Inc. or its affiliates.) When a user presses the button on the front of the Dash Button, a number of things happen inside it. First, the button press wakes it from a sleep state. Next, the device blinks a light-emitting diode (LED) white to let the user know the button has been pressed, and connects to the Internet over an existing Wi-Fi connection. Then, the device orders the product from Amazon by sending a simple message to Amazon, the same way that a person might fill out information on a website and press “send”.

### SUMMARY

In general, an approach for dynamically authenticating an identity of a user using an IOT device and empowering the IOT device to purchase, using an identity-linked financial account, a product or service on behalf of the authenticated user is provided. In an embodiment, a user performs an action on an input component (e.g., presses a button) of an IOT device to initiate a purchase transaction. Using captured biometric data of the user, an identity of the user is authenticated against an identity system, such as the Aadhaar-enabled biometric identification system. An identity-linked financial account is identified for the authenticated user. A payment is then authorized using the financial account to complete the purchase transaction.

A first aspect of the present invention provides a computer-implemented method for facilitating a purchase transaction using a biometric-enabled Internet of Things (IOT) device, comprising: initiating, in response to an action performed by a user on an input component of the IOT device, the purchase transaction; capturing, in response to receiving a confirmation prompt, biometric data associated with the user; authenticating, using the captured biometric data, an identity of the user; identifying, based on the identity of the user, an identity-linked financial account of the user; and authorizing a payment for the purchase transaction using the identity-linked financial account.

A second aspect of the present invention provides a computer program product for facilitating a purchase transaction using a biometric-enabled Internet of Things (IOT) device, the computer program product comprising a computer readable storage media, and program instructions stored on the computer readable storage media, that cause at least one computer device to: initiate, in response to an action performed by a user on an input component of the IOT device affixed to a product to be purchased, the purchase transaction for the product; collect by the IOT device, in response to receiving a confirmation prompt, biometric data associated with the user; authenticate, using the captured biometric data, an identity of the user; identify, based on the identity of the user, an identity-linked financial account of the user; and authorize a payment for the purchase transaction using the identity-linked financial account.

A third aspect of the present invention provides a system for facilitating a purchase transaction using a biometric-enabled Internet of Things (IOT) device, comprising: a memory medium comprising instructions; a bus coupled to the memory medium; and a processor coupled to the bus that when executing the instructions causes the system to: initiate, in response to an action performed by a user on an input component of the IOT device affixed to a product to be purchased, the purchase transaction for the product; collect by the IOT device, in response to receiving a confirmation prompt, biometric data associated with the user; authenticate, using the captured biometric data, an identity of the user; identify, based on the identity of the user, an identity-linked financial account of the user; and authorize a payment for the purchase transaction using the identity-linked financial account.

Still yet, any of the components of the present invention could be deployed, managed, serviced, etc., by a service provider who offers to implement the teachings of this invention in a computer system.

Embodiments of the present invention also provide related systems, methods, and/or program products.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computing environment according to an embodiment of the present invention.

FIG. 2 depicts a system diagram according to an embodiment of the present invention.

FIG. 3 depicts an example Internet of Things (IOT) device according to an embodiment of the present invention.

FIG. 4 depicts an example process flowchart according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which embodiments are shown. This disclosure may, however, be embodied in many different forms and should not be construed as limited to the embodiments set forth herein. Rather, these embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

The inventors of the current invention have identified certain deficiencies with current IOT devices. For example, the Dash Button needs to be pre-configured for use and fails to provide for dynamic authentication or authorization when used. In addition, each Dash Button device can be tied to only one payment method and account that has been set up when the device was initially configured. Anyone having possession (e.g., a child) could press the button, which may result in a product being mistakenly ordered. The invention described herein supports collection of biometric data from a user, which is integrated with an identity provider to authenticate an identity of the user. Only when authenticated will the invention enable accounting or payment of a product through a financial account, which is linked to the user. The invention brings together biometric-based authentication, an identity linked payment system, and IOT button capabilities to seamlessly establish a user identity to make a payment for a product on behalf of the user.

Embodiments of the present invention provide an approach for dynamically authenticating an identity of a user using an IOT device and empowering the IOT device to purchase, using an identity-linked financial account, a product or service on behalf of the authenticated user. In an embodiment, a user performs an action on an input component (e.g., presses a button) of an IOT device to initiate a purchase transaction. Using captured biometric data of the user, an identity of the user is authenticated against an identity system, such as the Aadhaar-enabled biometric identification system. An identity-linked financial account is identified for the authenticated user. A payment is then authorized using the financial account to complete the purchase transaction.

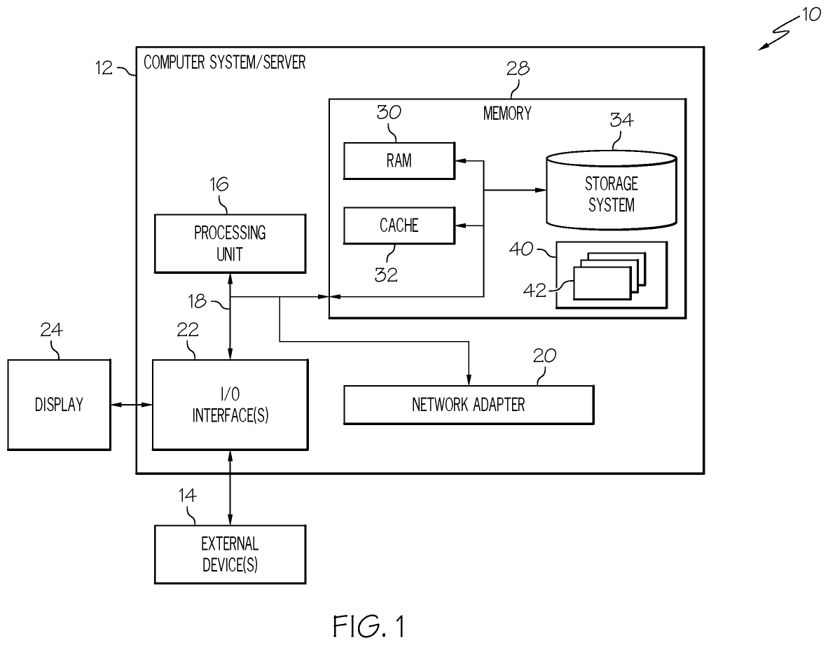

Referring now to FIG. 1, a schematic of an example of a computing environment is shown. Computing environment 10 is only one example of a suitable computing environment and is not intended to suggest any limitation as to the scope of use or functionality of embodiments of the invention described herein. Regardless, computing environment 10 is capable of being implemented and/or performing any of the functionality set forth hereinabove.

In computing environment 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, distributed cloud computing environments that include any of the above systems or devices, and/or the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in computing environment 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), an optical disk drive for reading from or writing to a removable, non-volatile optical disk such as a CD-ROM, DVD-ROM, and/or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

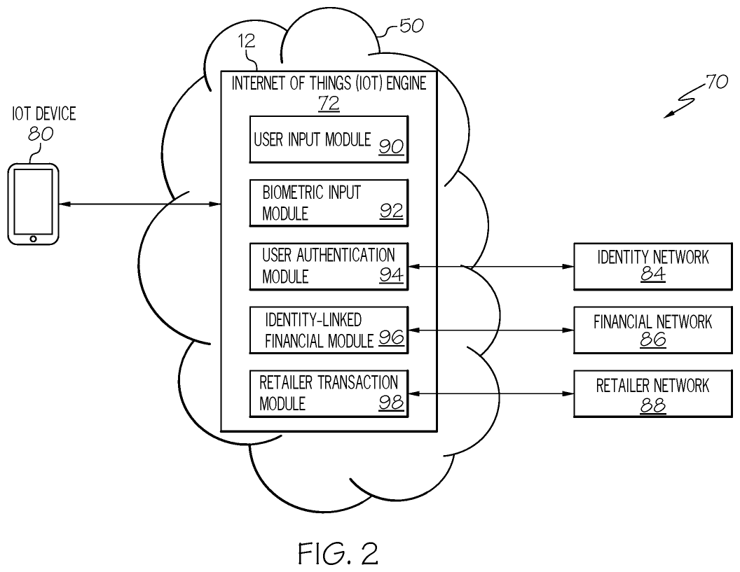

Referring now to FIG. 2, a system diagram describing the functionality discussed herein according to an embodiment of the present invention is shown. It is understood that the teachings recited herein may be practiced within any type of networked computing environment 70 (e.g., a cloud computing environment 50). A stand-alone computer system/server 12 is shown in FIG. 2 for illustrative purposes only. In the event the teachings recited herein are practiced in a networked computing environment 70, each client need not have an Internet of Things (IOT) engine (hereinafter “system 72”). Rather, system 72 could be loaded on a server or server-capable device that communicates (e.g., wirelessly) with client machines to provide trained neural network generation therefor. Regardless, as depicted, system 72 is shown within computer system/server 12. In general, system 72 can be implemented as program/utility 40 on computer system 12 of FIG. 1 and can enable the functions recited herein. It is further understood that system 72 may be incorporated within or work in conjunction with any type of system that receives, processes, and/or executes commands with respect to neural networks in a networked computing environment. Such other system(s) have not been shown in FIG. 2 for brevity purposes.

Along these lines, system 72 may perform multiple functions similar to a general-purpose computer. Specifically, among other functions, system 72 can dynamically authenticate an identity of a user using an IOT device and empower the IOT device to purchase, using an identity-linked financial account, a product or service on behalf of the authenticated user. To accomplish this, system 72 can include: a user input module 90, a biometric input module 92, a user authentication module 94, an identity-linked financial module 96, and a retailer transaction module 98.

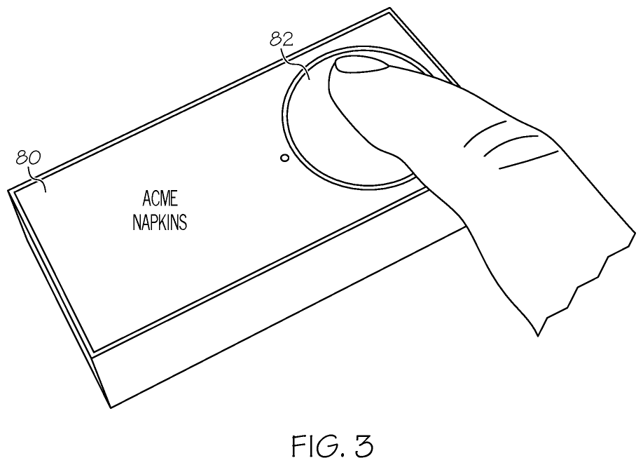

FIG. 3 shows an example Internet of Things (IOT) device 80 having an activator, such as button 82. An activator can include, but is not limited, to a button, switch, knob, dial, infrared sensor, motion sensor, proximity sensor, and/or the like. As shown, activator is button 82. IOT refers to the ever-growing network of physical objects that feature an internet protocol (IP) address for Internet connectivity, and the communication that occurs between these objects and other Internet-enabled devices and systems. IOT extends Internet connectivity beyond traditional devices like desktop and laptop computers, smartphones and tablets to a diverse range of devices and everyday things that utilize embedded technology to communicate and interact with the external environment, all via the Internet. Examples of objects that can fall into the scope of IOT include, but are not limited to, connected security systems, thermostats, cars, electronic appliances, lights in household and commercial environments, alarm clocks, speaker systems, vending machines, and/or the like. As shown, IOT device 80 is a small electronic device having button 82 which can be pressed by a user to perform a predefined function. In an embodiment, IOT device 80 has the ability to obtain biometric data. For example, IOT device 80 may include a fingerprint scanner, iris scanner, camera for facial recognition, and/or the like. In another embodiment, IOT device 80 can receive biometric data related to a user via a separate device, such as a smart phone.

User input module 90 of system 72, as executed by computer system/server 12, is configured to receive an input signal (or message) when an action is performed on an activator (e.g., button 82) of IOT device 80. Again, an activator can include a button, switch, dial, keypad, and/or the like that is capable of having an action performed on the input component, such as a press of a button, turn of a dial, flip of a switch, and/or the like. Again, as shown, IOT device 80 includes button 82. When button 82 is pressed, wireless connectivity can be enabled in IOT device 80 allowing IOT device 80 to wirelessly communicate with modules of system 72. For example, a signal received by user input module 90 can indicate an initiation of a process, such as placing an order for a particular product from a retailer. To that end, IOT device 80 may be pre-configured to communicate wirelessly with system 72. For example, IOT device 80 may connect to the Internet via a Wi-Fi chip embedded in IOT device 80 which can be switched on for use in communicating with system 72 via the Internet. In any case, IOT device 80 can be configured to wirelessly communicate with system 72 to assist in performing the functions described herein. Further, in an embodiment, an activator (e.g., button 82) may be reprogrammed to use for other purposes such as ordering a different product, tracking time, controlling one or more lights and/or outlets in a household configured to respond to such commands, and/or the like.

Biometric input module 92 of system 72, as executed by computer system/server 12, is configured to receive biometric data from a user utilizing IOT device 80 via one or more biometric inputs. As stated, an input signal is received by user input module 90 when an action is performed using an input component (e.g., press of button 82) on IOT device 80. When the input signal is received, biometric data of a user can be collected to authenticate an identity of the user. IOT device 80 may provide a confirmation prompt indicating to the user that a process has been initiated and IOT device 80 is ready to receive biometric data from the user. For example, an LED light may be switched on IOT device 80 when button 82 is pressed by a user to begin the process of ordering a product which alerts the user to now provide her biometric data for authentication. A biometric input may include, but is not limited to, obtaining a fingerprint, retina scan, palm print, face scan, and/or the like, for retrieving identifying information related to a user to authenticate the user for the process initiated. For example, IOT device 80 can include a fingerprint scanner and keypad for integrating with an Aadhaar system, as described below. Use of biometrics provides a means of identifying and authenticating an individual in a reliable, secure, and fast way, through the use of unique biological characteristics.

User authentication module 94 of system 72, as executed by computer system/server 12, is configured to authenticate an identity of a user utilizing IOT device 80. User authentication module 94 receives biometric information provided by a user from biometric input module 92. In an embodiment, biometric information input by the user using IOT device 80 is transmitted to identity network 84 to authenticate the identity of the user. In an example, identity network 84 may represent an Aadhaar-enabled biometric identification system. Aadhaar is a 12-digit unique identity number that can be obtained by residents of India, based on their biometric and demographic data. The number can be linked to the resident's basic demographic and biometric information such as a photograph, ten fingerprints and two iris scans, which can be stored in a centralized database. In an example, IOT device 80 may include a keypad and a fingerprint scanner. When interfacing with an Aadhaar system, a user can input her 12-digit unique identity number using the keypad and put her finger on the fingerprint scanner. If the identity number and fingerprint match those provided during enrollment in the Aadhaar system, then the user is successfully authenticated.

Identity-linked financial module 96 of system 72, as executed by computer system/server 12, is configured to identify a linked financial account related to an authenticated user in order to facilitate a purchase of a product or service. To accomplish this, a user must first have her identity linked to financial network 86. For example, financial network 86 may be a credit card institution, linked checking account, PayPal®, and/or the like, in which the user maintains a credit card account for making purchases of items and/or services. (PayPal is a registered trademark of PayPal, Inc.) When authenticated, user data (e.g., user photograph, demographic information, etc.) can be released to financial network 86 in order to determine whether a user has an identity-linked financial account at financial network 86 for use in making a purchase from retailer network 88.

Retailer transaction module 98 of system 72, as executed by computer system/server 12, is configured to, once a user has been authenticated and determined to have an identity-linked financial account, perform a financial transaction to purchase a product or service on behalf of a user. To that end, user data (e.g., credit card account data, shipping information, etc.) may be transmitted to financial network 86 to seamlessly charge the linked account to complete the purchase of the product. Referring back to FIG. 3, when user presses button 82, a purchase of product ACME napkins may be made from the retailer of retailer network 88. The payment and purchase request are authenticated and authorized in real time (or near real time) once button 82 is pressed. No pre-configuration of payment details is needed which reduces the security risk to the user's financial account. In an embodiment, a message (e.g., email message or receipt) can also be transmitted to an electronic device (e.g., smart phone, IOT device 80, etc.) notifying the user of a completed purchase or issue with the purchase.

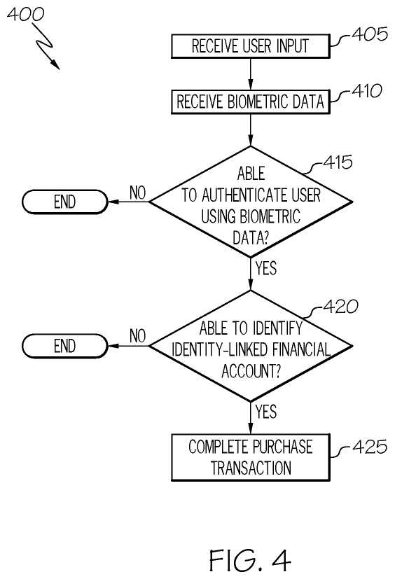

Referring now to FIG. 4 in conjunction with FIGS. 2 and 3, a method flow diagram 400 according to an embodiment of the present invention is shown. At 405, user input module 90 of system 72, as executed by computer system/server 12, receives an input signal (or message) when a user presses an activator on IOT device 80 to initiate a process to purchase a product or service. At 410, biometric input module 92 of system 72, as executed by computer system/server 12, receives biometric data from the user utilizing IOT device 80 via one or more biometric inputs. At 415, user authentication module 94 of system 72, as executed by computer system/server 12, attempts to authenticate the identity of a user utilizing IOT device 80 using the received biometric data. If unable to authenticate the user, the process ends. If able to authenticate, identity-linked financial module 96 of system 72, as executed by computer system/server 12, identifies a linked financial account related to the authenticated user in order to facilitate a purchase of a product or service, at 420. If able to identify an identity-linked financial account, retailer transaction module 98 of system 72, as executed by computer system/server 12, completes the financial transaction for the purchase of the product, at 425. If unable to identify, a purchase is not made.

The flowchart of FIG. 4 illustrates the architecture, functionality, and operation of possible implementations of systems, methods, and computer program products according to various embodiments of the present invention. In this regard, each block in the flowcharts may represent a module, segment, or portion of code, which comprises one or more executable instructions for implementing the specified logical function(s). It should also be noted that, in some alternative implementations, the functions noted in the blocks might occur out of the order depicted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

While shown and described herein as an approach for dynamically authenticating an identity of a user using an IOT device and empowering the IOT device to purchase, using an identity-linked financial account, a product or service on behalf of the authenticated user, it is understood that the invention further provides various alternative embodiments. For example, in one embodiment, the invention provides a method that performs the process of the invention on a subscription, advertising, and/or fee basis. That is, a service provider, such as a Solution Integrator, could offer to provide functionality for responding to a threat. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In another embodiment, the invention provides a computer-implemented method for dynamically authenticating an identity of a user using an IOT device and empowering the IOT device to purchase, using an identity-linked financial account, a product or service on behalf of the authenticated user. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, availability detector 118 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may also be a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

It is apparent that there has been provided approaches for dynamically authenticating an identity of a user using an IOT device and empowering the IOT device to purchase, using an identity-linked financial account, a product or service on behalf of the authenticated user. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

1. A computer-implemented method for facilitating a purchase transaction using a biometric-enabled Internet of Things (IOT) device, comprising:
initiating, in response to an action performed by a user on a physical input component of the IOT device affixed to a product to be purchased, the purchase transaction for the product;
collecting by a sensor on the IOT device, in response to receiving a confirmation prompt that confirms the action performed in the IOT device, biometric data associated with the user, the confirmation prompt being a non-textual signal that indicates that a process has been initiated and the IOT device is ready to receive the biometric data from the user;
authenticating, using the captured biometric data, an identity of the user;
identifying, based on the identity of the user, an identity-linked financial account of the user; and
authorizing a payment for the purchase transaction using the identity-linked financial account.

2. The computer-implemented method of claim 1, wherein the purchase transaction includes a purchase of a product or service.

3. The computer-implemented method of claim 1, wherein the input component includes a button located on the IOT device.

4. The computer-implemented method of claim 3, the initiating further comprising pressing the button located on the IOT device.

5. The computer-implemented method of claim 1, the authenticating further comprising transmitting the biometric data to an Aadhaar-enabled biometric identification system to authenticate the user.

6. The computer-implemented method of claim 1, further comprising charging the identity-linked account to complete the purchase transaction.

7. The computer-implemented method of claim 1, further comprising transmitting a receipt to the user related to the purchase transaction.

8. A computer program product for facilitating a purchase transaction using a biometric-enabled Internet of Things (IOT) device, the computer program product comprising a computer readable storage media, and program instructions stored on the computer readable storage media, that cause at least one computer device to:
initiate, in response to an action performed by a user on a physical input component of the IOT device affixed to a product to be purchased, the purchase transaction for the product;
collect by a sensor on the IOT device, in response to receiving a confirmation prompt that confirms the action performed in the IOT device, biometric data associated with the user, the confirmation prompt being a non-textual signal that indicates that a process has been initiated and the IOT device is ready to receive the biometric data from the user;
authenticate, using the captured biometric data, an identity of the user;
identify, based on the identity of the user, an identity-linked financial account of the user; and
authorize a payment for the purchase transaction using the identity-linked financial account.

9. The computer program product of claim 8, wherein the purchase transaction includes a purchase of a product or service.

10. The computer program product of claim 8, wherein the input component includes a button located on the IOT device.

11. The computer program product of claim 10, the instructions that cause the at least one computer device to initiate the purchase transaction when the button located on the IOT device is pressed.

12. The computer program product of claim 8, the instructions further causing the at least one computer device to transmit the biometric data to an Aadhaar-enabled biometric identification system to authenticate the user.

13. The computer program product of claim 8, the instructions further causing the at least one computer device to charge the identity-linked account to complete the purchase transaction.

14. The computer program product of claim 8, the instructions further causing the at least one computer device to transmit a receipt to the user related to the purchase transaction.

15. A system for facilitating a purchase transaction using a biometric-enabled Internet of Things (IOT) device, comprising:
a memory medium comprising instructions;
a bus coupled to the memory medium; and
a processor coupled to the bus that when executing the instructions causes the system to:
initiate, in response to an action performed by a user on a physical input component of the IOT device affixed to a product to be purchased, the purchase transaction for the product;
collect by a sensor on the IOT device, in response to receiving a confirmation prompt that confirms the action performed in the IOT device, biometric data associated with the user, the confirmation prompt being a non-textual signal that indicates that a process has been initiated and the IOT device is ready to receive the biometric data from the user;
authenticate, using the captured biometric data, an identity of the user;
identify, based on the identity of the user, an identity-linked financial account of the user; and
authorize a payment for the purchase transaction using the identity-linked financial account.

16. The system of claim 15, wherein the purchase transaction includes a purchase of a product or service.

17. The system of claim 15, wherein the input component includes a button located on the IOT device.

18. The system of claim 17, the instructions further causing the at least one computer device to initiate the purchase transaction when the button located on the IOT device is pressed.

19. The system of claim 15, the instructions further causing the at least one computer device to transmit the biometric data to an Aadhaar-enabled biometric identification system to authenticate the user.

20. The system of claim 15, the instructions further causing the system to charge the identity-linked account to complete the purchase transaction.
